(19) United States
(12) Patent Application Publication
(10) Pub. No.: US 2005/0187007 A1
(43) Pub. Date: Aug. 25, 2005

(54) Gaming machine

(75) Inventor: Kaoru Kuroiwa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/038,215

(22) Filed: Jan. 21, 2005

(30) Foreign Application Priority Data
Jan. 21, 2004 (JP) 2004-013352

(51) Int. Cl. A63F 13/00

(52) U.S. Cl. 463/20

(57) ABSTRACT

A gaming machine includes: a display device; a first game controller that performs a first game in which a plurality of symbols are stopped after being variably displayed on the display device and a winning combination is determined based on an arrangement of the stopped symbols; and a second game controller that performs a second game on the display device when a predetermined arrangement is aligned at the first game, the second game of a pinball game in which a flipper image is moved as being operated by a player to flip a ball image moving within a predetermined display region, wherein the second game controller determines a number of the ball image to be displayed on the display region in response to the stopped symbol or to the arrangement of the stopped symbols at the first game.

### CROSS-REFERENCE TO THE RELATED APPLICATION(S)

The application is based upon and claims a priority from prior Japanese Patent Application No. 2004-013352 filed on Jan. 21, 2004, the entire contents of which are incorporated herein by reference. The application is related to co-pending U.S. application claiming priorities on Japanese Patent Application No. 2004-018635. The co-pending application is expressly incorporated herein by reference.

### BACKGROUND OF THE INVENTION

1. Field of the Invention

The present invention relates to a gaming machine, such as a video slot machine and a slot machine, in which a first game is normally played and when a predetermined arrangement is aligned at the first game, a second game is played under different rules from those of the first game.

2. Description of the Related Art

Conventionally, a video slot machine and a slot machine (hereinafter referred to simply as a slot machine) are widely recognized as a gaming machine in which a winning combination is determined based on an arrangement of symbols and thus medals such as coins are paid out, and are generally beloved. In such a slot machine, when a start lever is operated after medals are inserted, a so-called first game is played. The first game is a game configured as follows. That is, a plurality of (e.g., three) reels on each periphery of which are arranged plurality of symbols rotate, and when the arrangement of symbols obtained when these reels stop falls in a predetermined winning mode, a number of medals responsive to the winning mode are paid out. As the winning mode of the first game, for example, there exist a so-called “large jackpot” for which 1000 or more medals are paid out and a so-called “small jackpot for which 1000 or fewer medals are paid out.

As the winning mode of the first game, in addition to the “large jackpot” and the “small jackpot”, there exists a so-called “winning a second game” that enables the second game to be played. There exists a gaming machine on which the second game can be played without inserting any further medal when the winning mode of the first game falls in the “winning a second game” (e.g., see JP-A-11-244453).

The second game is a game that is played under different rules from those of the first game, and a game generally called a bonus game or a free game is an example thereof. The second game provides a game advantageous to a player in most cases, so that a large number of medals can be won depending on the result of the second game.

### SUMMARY OF THE INVENTION

However, the second game on the conventional gaming machine is a game obtained by only changing part of the content of the first game or a game whose content is simple, wherein reels are only looked at without operating the gaming machine. Therefore, the sense of participation in the game decreases, which is not sufficient to maintain a player's interest without tiring the player.

Consequently, although expectation is placed on the second game because chances possible to win a large number of medals are given, the expectation on the second game itself that the second game can be enjoyed is low. Therefore, it is difficult to increase a player's interest by making the player interested in and concerned with the second game itself.

The invention has been made in view of the problems, and an object thereof is to provide a gaming machine that can increase a player's interest.

According to a first aspect of the invention, there is provided a gaming machine including: a display device; a first game controller that performs a first game in which a plurality of symbols are stopped after being variably displayed on the display device and a winning combination is determined based on an arrangement of the stopped symbols; and a second game controller that performs a second game on the display device when a predetermined arrangement is aligned at the first game, the second game of a pinball game in which a flipper image is moved as being operated by a player to flip a ball image moving within a predetermined display region of the display device, wherein the second game controller determines a number of the ball image to be displayed on the display region in response to the arrangement at the first game.

According to a second aspect of the invention, there is provided a computer-readable program product for causing a computer to execute: performing a first game in which a plurality of symbols are stopped after being variably displayed on a display device and a winning combination is determined based on an arrangement of the stopped symbols; determining a number of a ball image to be displayed on a predetermined display region of the display device in response to the arrangement at the first game; and performing a second game on the display device when the predetermined arrangement is aligned at the first game, the second game of a pinball game in which a flipper image is moved as being operated by a player to flip the ball image moving within the display region.

According to a third aspect of the invention, there is provided an automatic game performing method executed in a computer including the steps of: performing a first game in which a plurality of symbols are stopped after being variably displayed on a display device and a winning combination is determined based on an arrangement of the stopped symbols; determining a number of a ball image to be displayed on a predetermined display region of the display device in response to the arrangement at the first game; and performing a second game on the display device when the predetermined arrangement is aligned at the first game, the second game of a pinball game in which a flipper image is moved as being operated by a player to flip the ball image moving within the display region.

### BRIEF DESCRIPTION OF THE DRAWINGS

These and other objects and advantages of the present invention will be more fully apparent from the following detailed description taken in conjunction with the accompanying drawings, in which:

FIG. 1 is a perspective view showing in schematic form an example of a gaming machine 2 according to the invention;

FIG. 2 is a block diagram showing the internal configuration of the gaming machine 2 shown in FIG. 1;

FIG. 3 is a block diagram showing the configuration of a display control device 200 provided in the gaming machine 2 shown in FIG. 1;

FIG. 4 is a flowchart showing a sub-routine for performing a first game process executed in a main control circuit 60;

FIG. 5 is a flowchart showing a sub-routine for performing a winning process executed in the main control circuit 60;

FIG. 6 is a flowchart showing a sub-routine for performing a second game process executed in the main control circuit 60;

FIGS. 7A-7D are diagrams showing, in schematic form, screen images displayed on an upper display device 32U and a lower display device 32D of the gaming machine 2;

FIG. 8 is a diagram showing an example of a ball image number determination table used at Step S30 of the sub-routine shown in FIG. 6;

FIG. 9 is a diagram showing another example of the ball image number determination table used at Step S30 of the sub-routine shown in FIG. 6;

FIG. 10 is a perspective view showing in schematic form a slot machine according to the invention;

FIG. 11 is a longitudinal sectional view of a lower liquid crystal display and a reel that are provided in the slot machine shown in FIG. 10;

FIG. 12 is a disassembled perspective view of the lower liquid crystal display provided in the slot machine shown in FIG. 10;

FIG. 13 is an explanatory diagram showing, in schematic form, symbol examples formed on the periphery of the reel;

FIG. 14 is an explanatory diagram showing in schematic form the internal configuration of the slot machine shown in FIG. 10; and

FIG. 15 is an explanatory diagram showing in schematic form a progressive game system.

### DETAILED DESCRIPTION OF THE PREFERRED EMBODIMENTS

Referring now to the accompanying drawings, there is shown preferred embodiments of the invention.

The embodiment described below shows the case in which the invention is applied to a video slot machine as a preferred embodiment of a gaming machine according to the invention.

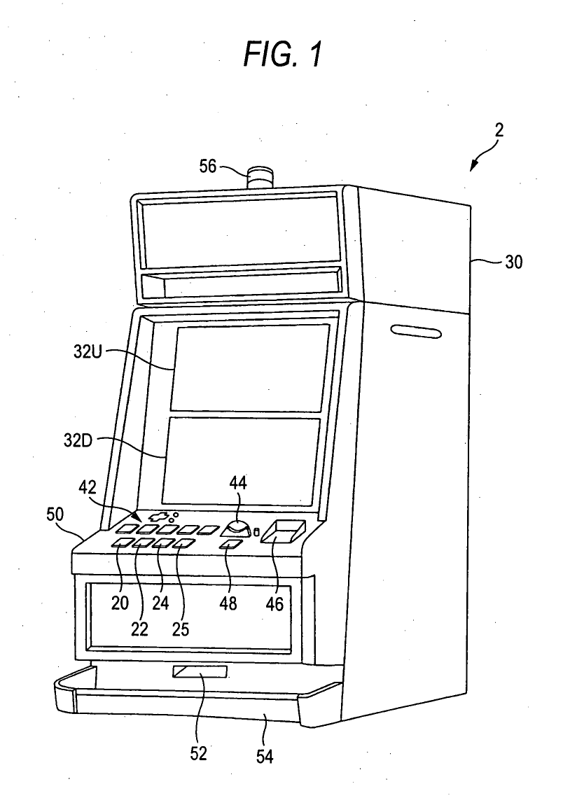

FIG. 1 is a perspective view showing in schematic form an example of the gaming machine of the invention.

A gaming machine 2 includes a housing 30. A front central portion of the housing 30 has a slope inclining slightly backward with respect to a vertical direction. Two display devices 32 (an upper display device 32U and a lower display device 32D) are disposed on the front of the housing 30 so as to be aligned in an up and down direction.

Additionally, in the gaming machine of the invention, the number of display devices is not particularly limited, and two display devices 32 (upper display device 32U and lower display device 32D) do not necessarily have to be provided as in the gaming machine 2.

An image showing a first game or a second game is displayed on the display devices 32 (upper display device 32U and lower display device 32D), and the first game or the second game proceeds on the display devices 32. When the first game is played, the upper display device 32U displays plural symbols, pay lines, etc. for use in playing a game modeled after a slot machine, and that the lower display device 32D displays various dramatic effect images.

The embodiment may be configured such that the lower display device 32D displays plural symbols, pay lines, etc. for use in playing the game modeled after the slot machine, and that the upper display device 32U displays various dramatic effect images.

The plural symbols are displayed as being illustrated on the periphery of a video reel that is displayed as an image modeled after a reel of the slot machine. The symbols are displayed changing so as to scroll in a predetermined direction when the game starts, and then displayed stopped with predetermined timing.

When a 1-BET switch 20, a 3-BET switch 22, or a maximum-BET switch 24, which switches will be described later, is pressed, then a pay line responsive to the BET switch pressed is activated. The invention can also be applied for example to a 5-reel-9-line video slot machine.

When an arrangement of symbols on the activated pay line falls in a winning mode corresponding for example to a “large jackpot” or a “small jackpot”, a number of coins responsive to the winning mode are paid out. When the arrangement of symbols on the activated pay line falls in a winning mode of “winning a second game”, a game image showing the second game is displayed on the display devices 32 and the second game proceeds on the display devices 32. The second game will be described later.

A description will hereinafter be given of the case in which a predetermined arrangement of the gaming machine 2 that causes the second game to be executed falls in the winning mode of “winning a second game”. Examples of the predetermined arrangement can be given as follows: a specific symbol (e.g., “JOKER”) should be displayed stopped within the display devices 32; the arrangement of specific symbol (e.g., the arrangement of four “Aces” aligned) should be aligned a predetermined number of times (e.g., five times); and the arrangement of specific symbol (e.g., the arrangement of five “7s” aligned) should be aligned. Needless to say, the predetermined arrangement of the gaming machine of the invention is not limited to these examples but can be set as appropriate.

A substantially horizontal pedestal portion 50 is provided below the lower display device 32D. Disposed on the left side of the top of the pedestal portion 50 are the 1-BET switch 20 that is pressed one time to thereby place a gaming bet of only one of already inserted coins, the 3-BET switch 22 that is pressed one time to place a gaming bet of only three of already inserted coins, and the maximum-BET switch 24 that is pressed one time to thereby place a gaming bet of the maximum number of already inserted coins that can be bet on one game. The BET switch 20, 22, or 24 is pressed to thereby validate a pay line in response to the BET switch pressed. A spin switch 25 for starting the game is disposed on the left side of the top of the pedestal portion 50. A player inserts coins into a coin insertion slot 44, depresses the BET switch 20, 22, or 24 to place a gaming bet of a predetermined number of coins, and then depresses the spin switch 25, thus making it possible to start the game.

An control panel 42 including a plurality of push buttons and a cross key is disposed at the back of the BET switches 20, 22, and 24 on the left side of the top of the pedestal portion 50. The control panel 42 is operated more ofthen when the second game is played. The coin insertion slot 44 and a bill insertion slot 46 are provided on the right side of the top of the pedestal portion 50. Coins or bills are inserted into these insertion slots, thereby making it possible to execute the game.

A payout switch 48 is also disposed in the vicinity of the coin insertion slot 44. The switch is pressed, whereby coins being inserted are paid out from a coin payout port 52 in a front lower portion of the housing 30, and the coins paid out are accumulated in a coin receiver 54.

Disposed on the top of the housing 30 is a warning lamp 56 that lights or flashes when malfunction of the gaming machine 2 is detected, when the player calls a attendant, or in like case, and thus that notifies the attendant to that effect.

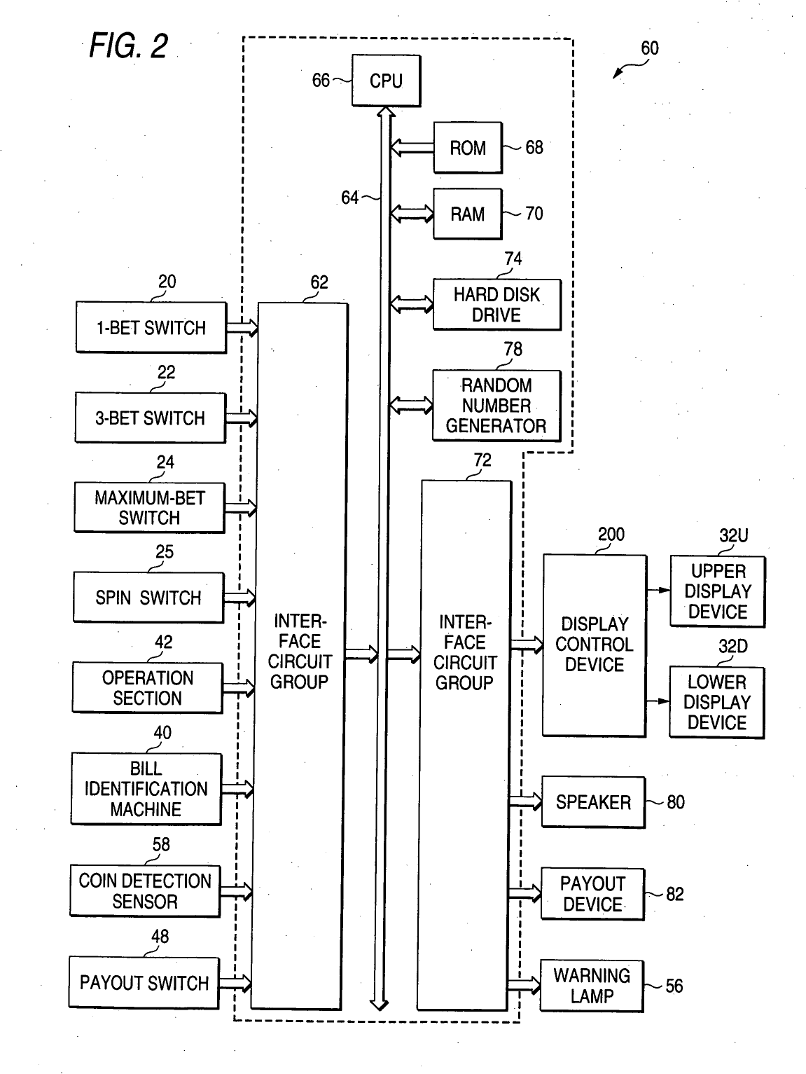

FIG. 2 is a block diagram showing the internal configuration of the gaming machine shown in FIG. 1.

The 1-BET switch 20, 3-BET switch 22, and maximum-BET switch 24 are connected to an interface circuit group 62 of a main control circuit 60, and the interface circuit group 62 is connected to an I/O bus 64. Each switch is pressed to generate a predetermined signal, thus supplying the signal to the I/O bus 64.

The control panel 42 including the plurality of push buttons and the cross key, and the spin switch 25 for starting the game are connected to the interface circuit group 62 of the main control circuit 60. The control panel 42 and the spin switch 25 are each operated to generate a predetermined signal, thus supplying the signal to the I/O bus 64.

The I/O bus 64 is configured to be able to input and output a data signal or an address signal from a CPU 66. In the embodiment, the CPU 66 transmits and receives signals from the external via the bus. Alternatively, the CPU 66 may perform the transmit/receive operation via a port.

A bill identification machine 40 and a coin detection sensor 58 are connected to the interface circuit group 62. When bills are inserted into the bill insertion slot 46, the bill identification machine 40 converts information about the kind and number of bills to a signal and transmits the signal to the interface circuit group 62. When coins are inserted into the coin insertion slot 44, the coin detection sensor 58 converts information about the kind and number of coins to a signal and transmits the signal to the interface circuit group 62.

The payout switch 48 is connected to the interface circuit group 62. When the player depresses the payout switch 48, a predetermined signal is supplied to the I/O bus 64, based on which signal, coins being inserted are paid out from the coin payout port 52 by a payout device 82.

A ROM 68 and a RAM 70 are connected to the I/O bus 64. The ROM 68 stores a control program for controlling the flow of the entire system of the gaming machine 2. The ROM 68 stores initial data for executing the control program, part of a program for performing display control of the display devices 32, etc., and the like. The RAM 7 stores the programs and data, and stores a flag, the value of a variable, etc. that serve as a calculation result and a processing result.

A hard drive 74 is also connected to the I/O bus 64. A program for performing the game and various data such as image data are stored into the hard drive 74. In place of the hard drive 74, the invention may use a nonvolatile memory of relatively large storage capacity such for example as a flash memory, or may use a volatile memory.

A random number generator 78 for generating a random number is connected to the I/O bus 64. When an instruction to generate a random number is issued from the CPU 66 to the random number generator 78, the random number generator 78 generates a random number within a predetermined range and supplies the I/O bus 64 with a signal indicative of the value of the random number generated. The CPU 66 causes the game to proceed based on the generated random number. The random number is stored into the RAM 70 as data indicative of a lottery result. The random number generator 78 may be realized software-wise by, for example, the CPU 66, the program stored in the ROM 68, and the RAM 70.

An interface circuit group 72 is also connected to the I/O bus 64. A speaker 80, the warning lamp 56, and the payout device 82 are connected to the interface circuit group 72. The interface circuit group 72 supplies drive signals and drive power so as to control the individual devices in response to the result of calculation processing of the CPU 66. The warning lamp 56 lights or flashes when malfunction of the gaming machine 2 is detected, when the player calls a attendant, or in like case, thus notifying the attendant to that effect. An LED, a lamp, and a fluorescent bulb can be given as examples of the warning lamp 56.

A display control device 200 is also connected to the interface circuit group 72. Based on an image instruction signal issued from the main control circuit 60, the display control device 200 issues a drive signal for driving the display devices 32 (upper display device 32U and lower display device 32D) connected to the display control device 200.

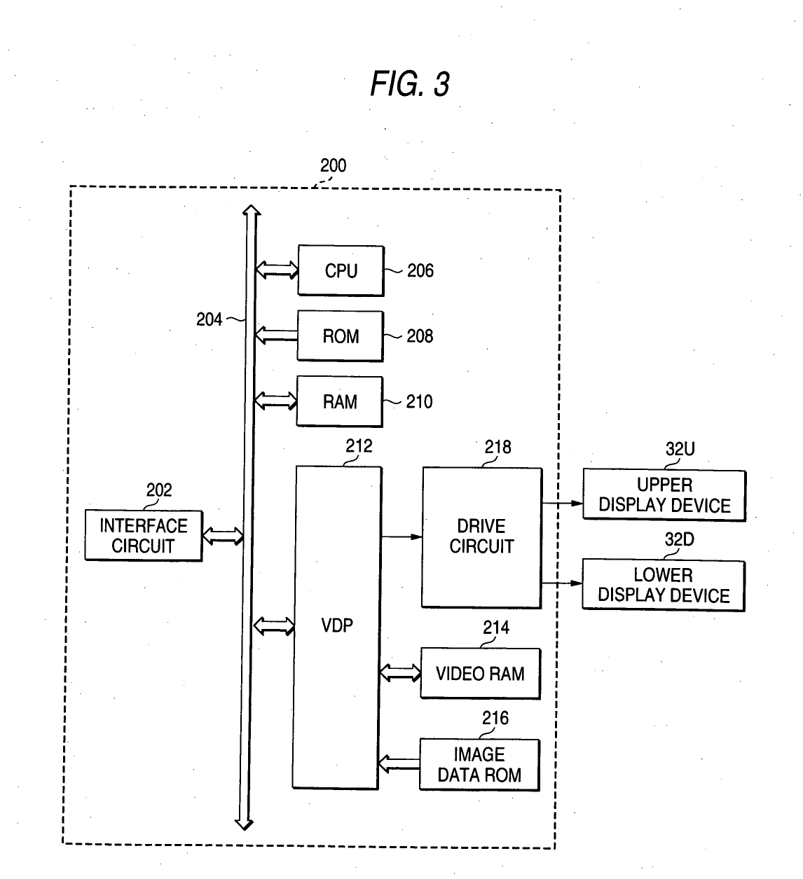

FIG. 3 is a block diagram showing the configuration of the display control device 200 provided in the gaming machine 2 shown in FIG. 1.

An interface circuit 202 is connected to an I/O bus 204. The image display instruction issued from the main control circuit 60 is supplied to the I/O bus 204 via the interface circuit 202. The I/O bus 204 is configured to input and output a data signal or an address signal from a CPU 206. In the embodiment, the CPU 206 transmits and receives signals from the external via the bus. Alternatively, the CPU 206 may perform the transmit/receive operation via a port.

A ROM 208 and a RAM 210 are also connected to the I/O bus 204. The ROM 208 stores a display control program for generating a drive signal that is supplied to the display devices 32 (upper display device 32U and lower display device 32D) based on the image display instruction issued from the main control circuit 60. On the contrary, the RAM 210 stores a flag and the value of a variable that are used in the display control program.

A video data processor (hereinafter called a VDP) 212 is also connected to the I/O bus 204. The VDP 212 is a processing device that includes circuits such as a sprite circuit, a screen circuit, and a pallet circuit, and that can perform various processes for displaying images on the display devices 32 (upper display device 32U and lower display device 32D).

The VDP 212 is connected with a video RAM 214 for storing image data responsive to the image display instruction issued from the main control circuit 60 and with an image data ROM 216 for storing various image data necessary to perform the first game and the second game. The VDP 212 is also connected with a drive circuit 218 that issues a drive signal for driving the display devices 32 (upper display device 32U and lower display device 32D).

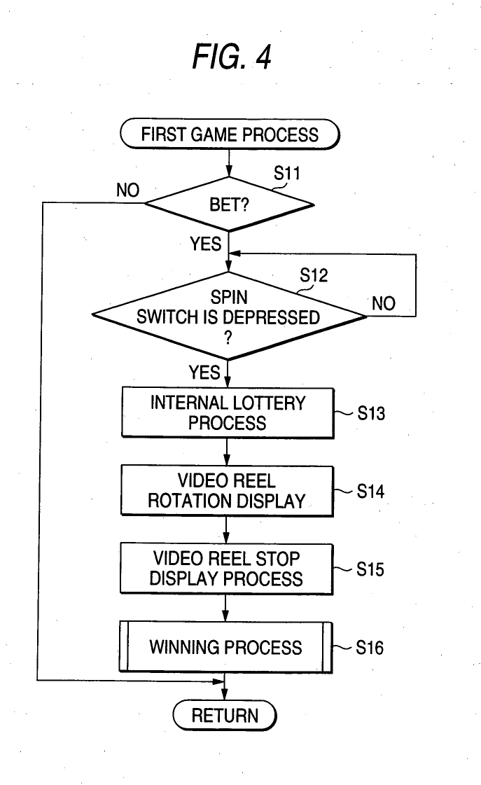

The CPU 206 reads and executes the display control program stored in the ROM 208, thereby causing the video RAM 214 to store the image data that is displayed on the display devices 32 (upper display device 32U and lower display device 32D) in response to the image display instruction issued from the main control circuit 60. The image data stored into the video RAM 214 is outputted via the drive circuit 218 to the display devices 32 (upper display device 32U and lower display device 32D). The internal configuration of the gaming machine of the invention is not limited to the examples shown in FIGS. 3 and 4.

FIGS. 4 to 6 show sub-routines for controlling the gaming machine 2 that are executed in the main control circuit 60. The variable that is pre-started and is used in the CPU 66 is hereinafter defined as being initialized to have a predetermined value and being in steady operation.

FIG. 4 is a flowchart showing a sub-routine for performing a first game process that is executed in the main control circuit 60.

The sub-routine is a sub-routine that is invoked from a pre-executed main routine with predetermined timing and then executed.

First, it is determined whether coins have been bet or not (Step S11). The process determines whether or not the CPU 66 has received a signal to the effect that the player has performed a BET process. The process proceeds to Step S12 when it is determined that the CPU 66 has received the signal, while the sub-routine is put to an end when it is determined that the CPU 66 has not received the signal.

The BET process may be configured to be automatically performed when the player inserts coins. The configuration may be such that a bet is not placed until the player depresses any one of the 1-BET switch 20, 3-BET switch 22, and maximum-BET switch 24.

Next, it is determined whether the spin switch 25 for commanding to start the game has been pressed or not (Step S12). The process determines whether or not the CPU 66 has received a signal to the effect that the player has pressed the spin switch 25. The process proceeds to Step S13 when it is determined that the CPU 66 has received the signal, while the process of Step 12 is executed again when it is determined that the CPU 66 has not received the signal.

Next, an internal lottery process is performed (Step S13). In the process, the CPU 66 instructs the random number generator 78 to generate a random number, and the random number generator 78 having received the instruction generates the random number. And, the CPU 66 stores internal lottery data based on the obtained random number into a predetermined region of the RAM 70. Additionally, the internal lottery data includes data indicative of an arrangement mode of symbols that can be displayed stopped as a specific jackpot win or a small jackpot win is hit.

The embodiment may be configured such that a random number is generated software-wise by the CPU 66, the program stored in the ROM 68, the RAM 70, and the like (e.g., subjected to a predetermined update to a numerical value in a constant or inconstant cycle), and that the internal lottery data is stored into the predetermined region of the RAM 70 based on the random number. In this case, the random number generator 78 can be omitted.

Next, a video reel rotation display process is performed (Step S14). In the process, the CPU 66 transmits a signal to the display control device 200 so as to start the game modeled after the slot machine on the upper display device 32U, i.e., so as to rotate the video reels displayed as images on the upper display device 32U. The signal also includes symbol image data for determining the arrangement of symbols displayed stopped, based on the internal lottery data. And, based on the signal, the display control device 200 displays the video reels rotating on the upper display device 32U, thereby starting the variable displaying of plural symbols. Furthermore, during execution of the first game, based on the signal transmitted from the CPU 66, the display control device 200 also performs the process of displaying various dramatic effect images on the lower display device 32D.

Next, a video reel stopped display process is performed (Step S15). In the process, the CPU 66 transmits a signal to the display control device 200 so as to terminate the game modeled after the slot machine on the upper display device 32U, i.e., so as to stop the rotation of the video reels displayed as images on the upper display device 32U. The display control device 200 performs the stopped display of the plural symbols after performing the variable displaying of the plural symbols over a predetermined period.

Next, a winning process is performed (Step S16). In the process, the CPU 66 performs the winning process based on symbol or arrangement of the symbols that is displayed stopped or on the internal lottery data. The process will be described later. After the process of Step S16 ends, the sub-routine is put to an end.

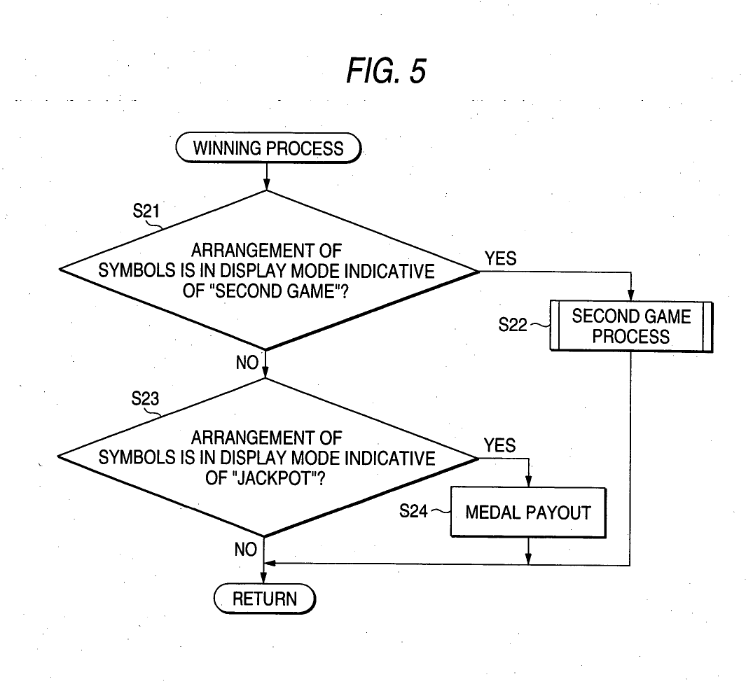

FIG. 5 is a flowchart showing a sub-routine for performing the winning process that is executed in the main control circuit 60.

The sub-routine is a sub-routine that is invoked and executed at Step S16 of the sub-routine shown in FIG. 4.

First, it is determined whether symbol or arrangement of the symbols that is displayed stopped is in the winning mode of “winning a second game” or not (Step S21). In the process, the CPU 66 determines whether symbol or arrangement of the symbols that is displayed stopped at Step S15 of the sub-routine shown in FIG. 4 indicates a transition to the second game or not.

When it is determined that the transition to the second game is indicated, the CPU 6 executes a second game process (Step S22). The second game can be played without inserting any further coin and is played under different rules from those of the first game. The second game will be described in detail later.

When Step S21 determines that the symbol or arrangement of the symbols that is displayed stopped does not indicate the transition to the second game, next, it is determined whether the symbol or arrangement of the symbols that is displayed stopped is in a winning mode of jackpot (“large jackpot” or “small jackpot”) or not (Step S23). When it is determined that the symbol or arrangement of the symbols that is displayed stopped is in the winning mode of jackpot, the CPU 66 drives the payout device 82 to perform the process of paying out a number of coins responsive to the winning mode into the coin receiver 54 via the coin payout port 52 (Step S24). For example, 1000 coins are paid out when the winning mode is of “large jackpot”, while 500 coins are paid out when the winning mode is of “small jackpot”. The sub-routine is put to an end when Step S23 determines that the symbol or arrangements of the symbols is not in the winning mode of jackpot, or when the process of Step S22 or S24 is performed. While the sub-routines shown in FIGS. 4 and 5 are executed, the main control circuit 60 functions as the first game controller.

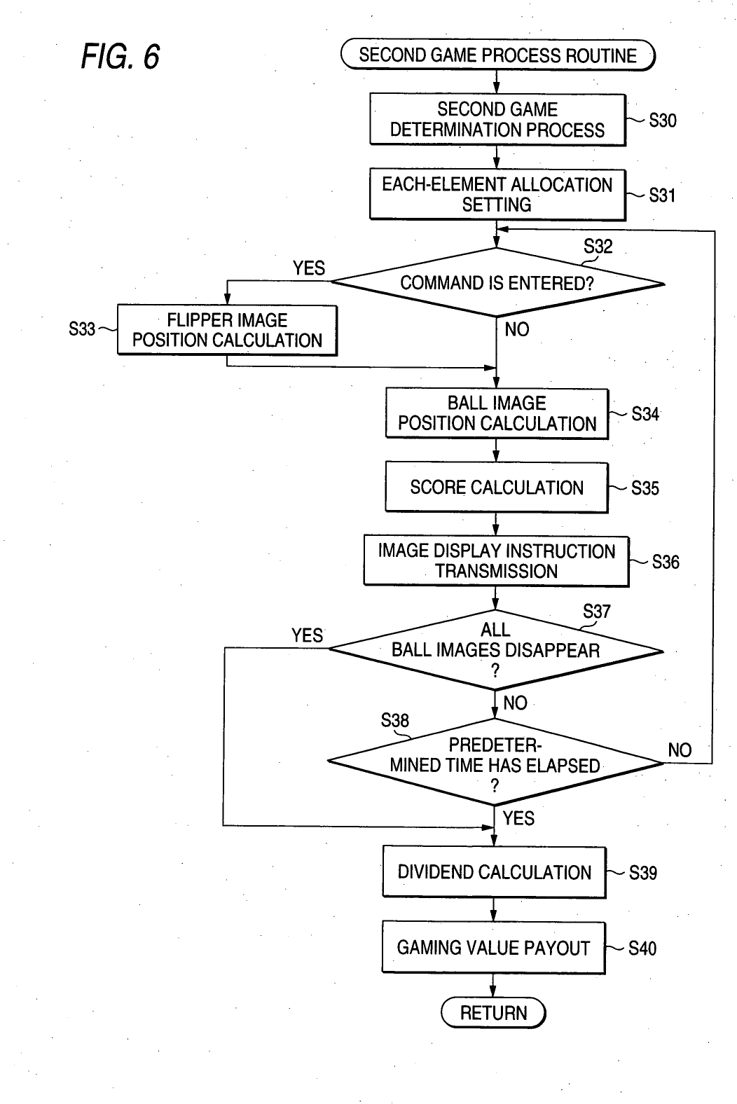

FIG. 6 is a flowchart showing a sub-routine for performing the second game process that is executed in the main control circuit 60. The sub-routine is a sub-routine that is invoked and executed at Step S22 of the sub-routine shown in FIG. 5.

First, the CPU 66 determines the number of balls (Step S30). In the process, the CPU 66 determines the number of ball images appearing in a pinball game played as the second game, in response to symbol or arrangement of the symbols that is displayed stopped at the first game having the predetermined arrangement aligned thereat.

To give specific examples, the number of ball images is determined to be 5 when the arrangement of symbols displayed stopped at the first game is of “Ace”, 4 when the arrangement is of “King”, 3 when the arrangement is of “Queen”, and 2 when the arrangement is of another symbol.

Next, the allocation of individual elements appearing in the pinball game is set (Step S31).

In the process, the CPU 66 sets coordinates for allocating the individual elements. The elements appearing in the pinball game are not particularly limited, but a playfield, a ball, flippers, bumpers, a hole, a guide, and lanes can be cited as examples of such elements, and the individual elements are displayed as images on the gaming machine 2.

The playfield image is such that the ball image can move thereon, and a display region in which the playfield image is displayed corresponds to a predetermined display region in which the ball image is movable.

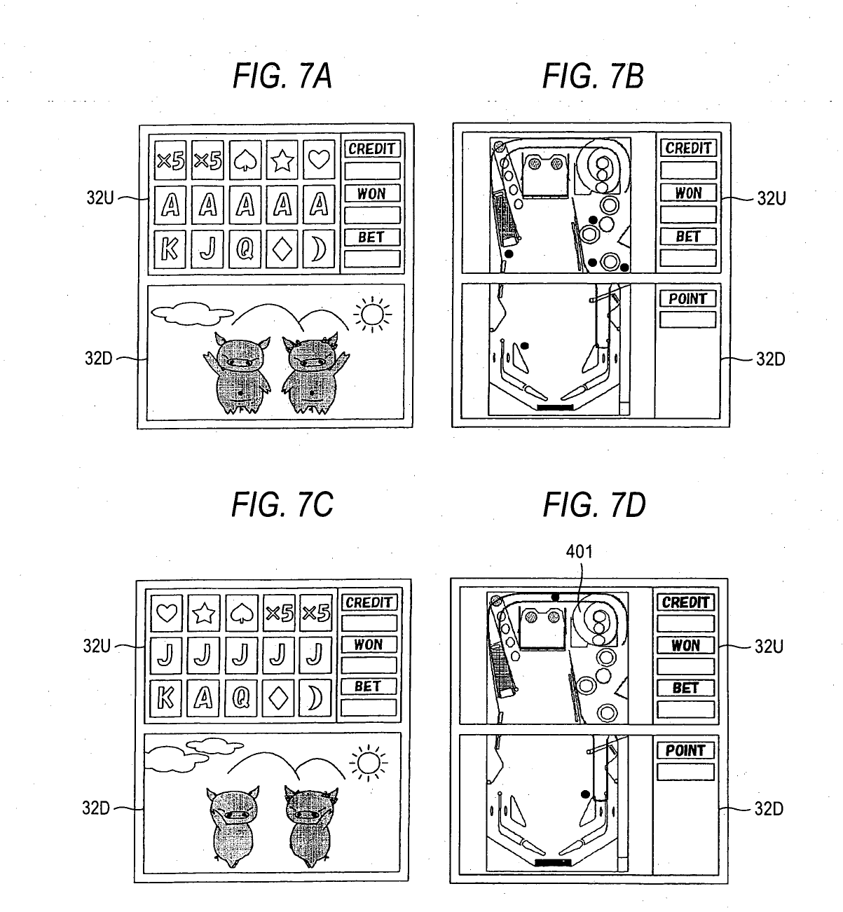

The ball image moves on the playfield image. Flipper images are intended for flipping the ball image. One end of each of the flipper images is fixed to specific coordinates, and the player operates the control panel 42, thereby allowing each flipper image to rotate and reciprocate about the one end within a predetermined range. The bumper images are arranged on the playfield image, and when the ball image hits against the bumper images, the direction of movement of the ball image changes and points are awarded for such a hit. The hole image is allocated to the lowest side on the playfield image, and when the ball image falls on the hole image, the ball image disappears from within the playfield image. The guide image 401 of FIG. 7D is arranged on the playfield image and changes the direction of movement of the ball image. The lane images are arranged on the playfield and guide the ball image from one place to another. Out of these images, the ball image and the playfield image are elements essential for playing the pinball games, and other elements can be arbitrarily selected.

Next, it is determined whether a command to operate the flipper images has been entered or not (Step S32). In the process, the CPU 66 determines whether or not a command to operate the flipper images has been entered via the control panel 42. When it is determined that the command to operate the flipper images has been entered, the process of calculating the position of the flipper images is performed (Step S33).

When Step S33 determines that the command to operate the flipper images has not been entered, or when the process of Step S33 is executed, the CPU 66 calculates the position of the ball image (Step 34). In the process, the CPU 66 calculates coordinates serving as the destination of one or two or more ball images allocated on the playfield image, based on a gravity element obtained by inclination of a hypothetical playfield and also on the interference of the individual elements.

When a ball image contacts the flipper images in operation, the CPU 66 calculates the coordinates of the destination of the ball image so that the ball image flips upward. When the coordinates serving as the destination of the ball image belongs to the position allocated with the hole image, the CPU 66 causes the ball image to disappear from within the playfield.

Next, the CPU 66 calculates score (Step S35).

That is, when the ball image hits against the bumper images based on the calculation result of Step S34, or when the ball image passes through a predetermined region on the playfield image based on the calculation result, the CPU 66 calculates score responsive to such a situation and then causes the RAM 70 to store the score as points. Additionally, when the points are already stored in the RAM 70, points to be freshly awarded are cumulatively added and stored thereinto.

Next, the CPU 66 transmits an image display instruction to the display control device 200, based on the position of each element set at Step S31, the position of the flipper images calculated at Step S33, the position of the ball image calculated at Step S34, and the score calculated at Step S35 (Step S36).

Based on the image display instruction, the display control device 200 displays the image showing the pinball game including the ball image, flipper images, etc. on the display devices 32 (upper display device 32U and lower display device 32D).

Next, it is determined whether all the ball images have disappeared from within the display region or not (Step S37). In the process, based on the calculation result of Step S34, the CPU 66 determines whether all the ball images have disappeared from within the playfield or not.

When Step S37 determines that all the ball images have not disappeared from within the display region, the CPU 66 determines whether or not a predetermined time has elapsed after the second game starts (Step S38).

When Step S38 determines that the predetermined time has not elapsed after the second game starts, the process returns to Step S32, and the processes of Steps S32 to S38 are repeatedly executed.

When Step S37 determines that all the ball images have disappeared from within the display region, or when Step S38 determines that the predetermined time has elapsed after the second game starts, it follows that the second game ends, so that the CPU 66 performs the process of calculating a award (Step S39). The award refers to the number of coins paid out as the result of the second game and is calculated based on the number of coins bet at the first game and the score won at the second game. Next, the CPU 66 drives the payout device 82 to perform the process of paying out a number of coins responsive to the award (Step S40), and then puts the sub-routine to an end. When the sub-routine shown in FIG. 6 is executed, the main control circuit 60 functions as the second game controller.

FIGS. 7A-7D are diagrams showing, in schematic form, screen images that are displayed on the upper display device 32U and the lower display device 32D when the sub-routines shown in FIGS. 4 to 6 are executed. In the figures, the ball images are indicated by images made of circles filled in with black.

The screen image shown in FIG. 7A is an example of a screen image displayed on the display devices 32 immediately after the first game ends. A screen image showing a game modeled after the 5-reel-9-line slot machine is displayed on the upper display device 32U. Five symbols “Aces” are displayed stopped on a central activated payline. A dramatic effect image is displayed on the lower display device 32D.

When the second game starts thereafter, a screen image shown in FIG. 7B is displayed.

The screen image includes an image showing a pinball game, and furthermore the image showing the pinball game includes a pair of flipper images and five ball images.

In this case, the player can play a pinball game that is played such that the control panel 42 is operated to thereby rotate and reciprocate the flipper images within a predetermined range, thus flipping the five ball images into the playfield image.

A screen image shown in FIG. 7C is another example of the screen image that is displayed on the display devices 32 immediately after the first game ends. A screen image showing the game modeled after the 5-reel-9-line slot machine is displayed on the upper display device 32U. Five symbols “Jacks” are displayed stopped on a central activated pay line. Besides, a dramatic effect image is displayed on the lower display device 32D.

When the second game starts thereafter, a screen image shown in FIG. 7D is displayed.

The screen image includes an image showing a pinball game, and furthermore the image showing the pinball game includes a pair of flipper images and two ball images.

In this case, the player can play a pinball game that is played such that the control panel 42 is operated to thereby rotate and reciprocate the flipper images within a predetermined range, thus flipping the two ball images into the playfield image.

As above, according to the gaming machine 2, the number of ball images becomes 5 when symbols are displayed stopped making the arrangement of “Aces” at the first game, while the number of ball images becomes 2 when symbols are displayed stopped making the arrangement of “Jacks” at the first game. In the way, the number of ball images is not always constant, but a number of ball images responsive to the result of the first game are used, which therefore will not tire the player and can improve game's amusing properties.

On the gaming machine 2, the player himself/herself can operate the flipper images to play the second game, which therefore makes the player interested in and concerned with the second game itself, so that the player can enjoy the second game.

The gaming machine 2 is configured such that the number of ball images to be used at the second game is determined in response to the arrangement of symbols displayed stopped at the first game. Alternatively, the embodiment may be configured as follows. For example, the number of ball images is set to 5 when a specific symbol is included in any of the plural symbols displayed stopped at the first game. And, the number of ball images is set to 2 when the specific symbol is not included therein. In the way, the number of ball images is determined not in response to the arrangement of symbols displayed stopped at the first game, but in response to the symbols displayed stopped at the first game.

In the embodiment, the number of ball images to be used at the second game does not necessarily have to be determined in response to symbol or arrangement of the symbols that is displayed stopped at the first game.

The embodiment may be configured as follows. That is, a lottery is held upon determination of the number of ball images. Then, the number of ball images to be used at the second game is determined in response to the result of the lottery and to symbol or arrangement of the symbols that is displayed stopped at the first game.

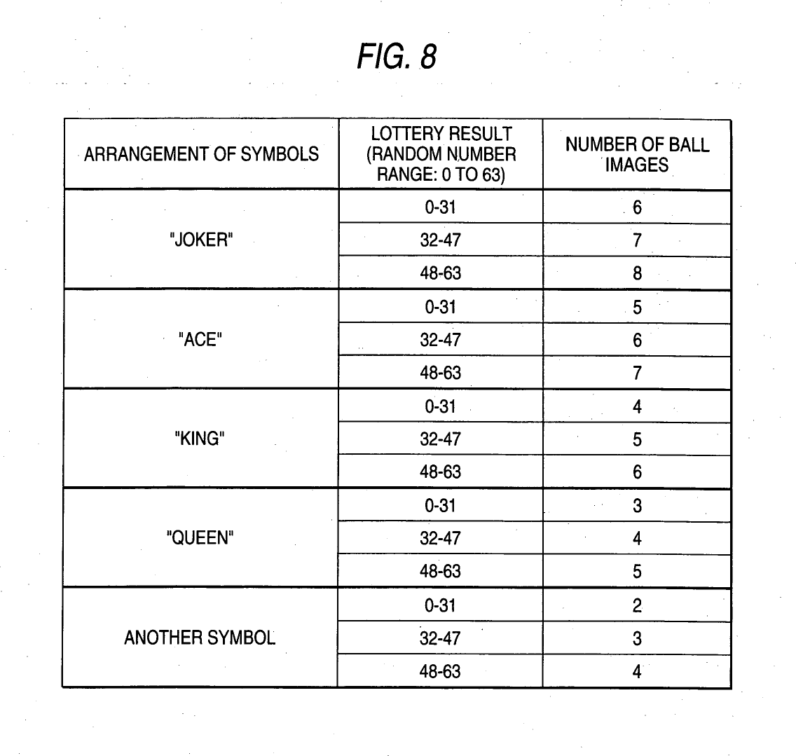

In such a case, a lottery is held at Step S30 (ball number determination process) of the sub-routine shown in FIG. 6, and with reference to a ball image number determination table shown in FIG. 8, the number of ball images to be used at the second game can be determined in response to the result of the lottery and to symbol or arrangement of the symbols that is displayed stopped at the first game.

FIG. 8 is a diagram showing an example of the ball image number determination table used at Step S30 of the sub-routine shown in FIG. 6.

“Arrangement of Symbols” in the leftmost column of the ball image number determination table shows the arrangement of symbols displayed stopped at the first game. “Lottery Result” in the center of the table shows the range of the random number value drawn at the lottery. At the lottery, a random number “1” is drawn from within a range of 0 to 63.

For example, the number of ball images is 5 when the “Arrangement of Symbols” is of “Ace” and the “Lottery Result” is “1”. The number of ball images is 4 when the “Arrangement of Symbols” is of “Jack (another symbol)” and the “Lottery Result” is “63”.

The number of ball images to be used at the second game is thus determined in response not only to symbol or arrangement of the symbols that is displayed stopped at the first game, but also to the symbol or arrangement of the symbols and the result of a lottery held thereafter. Accordingly, it can provide the second game with more diversity and thus can improve game's amusing properties.

The embodiment may be configured such that the number of ball images to be used at the second game is determined in response to symbol or arrangement of the symbols that is displayed stopped at the first game and to the number of game media used at the first game.

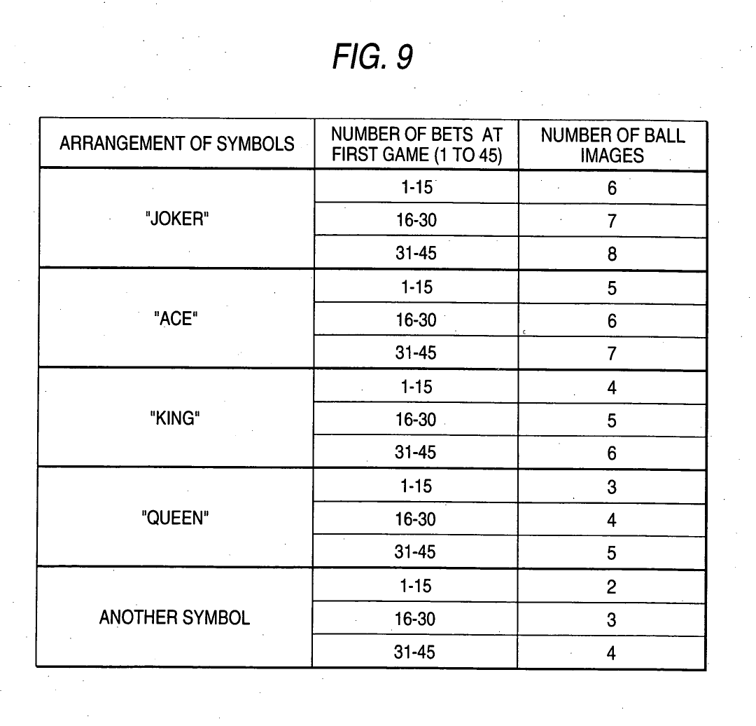

In such a case, at Step S30 of the sub-routine shown in FIG. 6, with reference to a ball image number determination table shown in FIG. 9, the number of ball images to be used at the second game may be determined in response to symbol or arrangement of the symbols that is displayed stopped at the first game and to the number of game media used at the first game.

FIG. 9 is a diagram showing another example of the ball image number determination table that is used at Step S30 of the sub-routine shown in FIG. 6.

“Arrangement of Symbols” in the leftmost column of the ball image number determination table shows the arrangement of symbols displayed stopped at the first game. “Number of Bets at First Game” in the center of the table shows the range of the number of game media used at the first game. Additionally, 1 to 45 game media can be used at the first game.

For example, the number of ball images is 5 when the “Arrangement of Symbols” is of “Ace” and the “Number of Bets at First Game” is 10. The number of ball images is 4 when the “Arrangement of Symbols” is of “Jack (another symbol)” and the “Number of Bets at First Game” is 45.

Herein, the “Number of Bets” means a total number of bets of the coins made in the first game.

The number of ball images to be used at the second game is thus determined in response not only to symbol or arrangement of the symbols that is displayed stopped at the first game, but also to the symbol or arrangement of the symbols and the number of game media used at the first game. The can provide the second game with diversity. The game media used at the first game are increased and decreased in number, whereby the number of ball images to be used at the second game can be varied on player's own will, so that the second game can be given strategic properties.

The gaming machine 2 has been described such that an image showing a pinball game is displayed straddling the upper display device 32U and the lower display device 32D. However, the gaming machine of the embodiment may be configured such that an image showing a pinball game is displayed on any one of the upper display device 32U and the lower display device 32D. The gaming machine of the embodiment may be configured such that an image showing a pinball game is displayed on each of the upper display device 32U and the lower display device 32D and that two pinball games can thus be played at the same time.

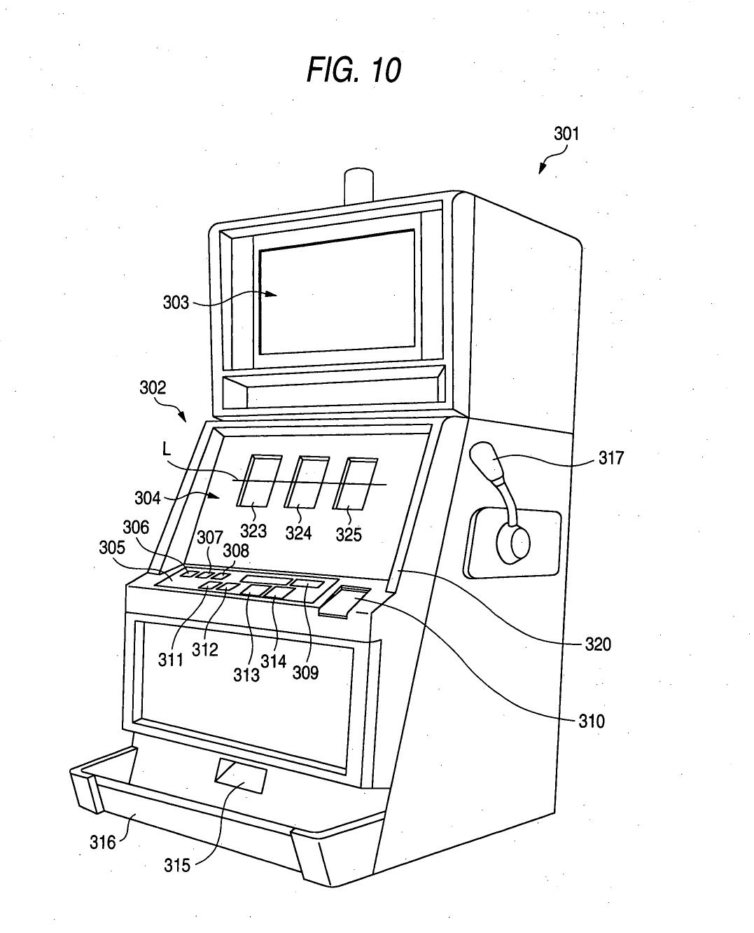

The invention can be applied to the following slot machine. FIG. 10 is a perspective view showing in schematic form an example of a slot machine according to the invention.

In FIG. 10, a slot machine 301 has a cabinet 302 forming the whole thereof. An upper liquid crystal display 303 is disposed in a front upper portion of such a cabinet 302. A lower liquid crystal display 304 is disposed in a front central portion of the cabinet 302. Here, the upper liquid crystal display 303 is made up of a liquid crystal display that is generally used for various purposes, and the lower liquid crystal display 304 is made up of a so-called transparent liquid crystal display. The detail of the lower liquid crystal display will be described in detail later.

An operation table 305 protruding to the near side is provided below the lower liquid crystal display 304. A CHANGE button 306, a CASH-OUT button 307, and a HELP button 308 are disposed on such an operation table 305 in the order named from the leftmost side, and a coin insertion portion 309 and a bill insertion portion 310 are provided on the right side of the HELP button 308. Besides, a 1-BET button 311, a SPIN/REPEAT-BET button (abbreviated hereinafter to “SPIN button”) 312, a 3-BET button 313, and a 5-BET button 314 are disposed on the near side of the operation table 305 in the order named from the left side.

Here, the CHANGE button 306 is a button that is pressed when a bill inserted into the bill insertion portion 310 is changed into coins. The coins are paid out from a coin payout port 315 provided in a lower portion of the cabinet 302 into a coin receiver 316. Such a CHANGE button 306 is annexed with a CHANGE switch 362, and based on depression of the CHANGE button 306, a switch signal is outputted from the CHANGE switch 362 to a CPU 350.

The CASH-OUT button 307 is a button that is normally pressed when a game ends. When the CASH-OUT button 307 is pressed, coins won at the game are paid back from the coin payout port 315 into the coin receiver 316. The CASH-OUT button 307 is annexed with a CASH-OUT switch 363, and based on depression of the CASH-OUT button 307, a switch signal is outputted to the CPU 350.

The HELP button 308 is a button that is pressed when it is not clear, for example, how to operate the game. When the HELP button 308 is pressed, various help information are displayed on the upper liquid crystal display 303 and the lower liquid crystal display 304. Such a HELP button 308 is annexed with a HELP switch 364, and based on depression of the HELP button 308, a switch signal is outputted from the HELP switch to the CPU 350.

A coin sensor 365 is disposed in the coin insertion portion 309, and when a coin is inserted into the coin insertion portion 309, a coin detection signal is outputted to the CPU 350 via the coin sensor 365. A bill sensor 366 is disposed in the bill insertion portion 310, and when a bill is inserted into the bill insertion portion 310, a bill detection signal is outputted to the CPU 350 via the bill sensor 366.

The 1-BET button 311 is a button for placing one bet per depression and can be pressed up to three times for betting. The 1-BET button 311 is annexed with a 1-BET switch 359, and when the 1-BET button 311 is pressed, then based on the depression, a switch signal is outputted from the 1-BET switch 359 to the CPU 350.

The SPIN button 312 is a button based on depression of which a reel 322 starts rotating to start a game with the current number of bets or the preceding number of bets. The SPIN button 312 is annexed with a SPIN switch 358, and when the SPIN button 312 is pressed, then based on the depression, a switch signal is outputted from the SPIN switch 358 to the CPU 350. Additionally, 1, 2, 3, and 5 bets can exist as the number of bets that can be placed by depressing the SPIN button 312.

The 3-BET button 313 is a button for starting a game with three bets based on depression thereof. Such a 3-BET button 313 is annexed with a 3-BET switch 360, and when the 3-BET button 313 is pressed, a switch signal is outputted from the 3-BET switch 360 to the CPU 350. The 5-BET button 314 is a button that is pressed when a game is started with five bets based on the depression. The 5-BET button 314 is annexed with a 5-BET switch 361, and based on depression of the 5-BET button 314, a switch signal is outputted from the 5-BET switch 361 to the CPU 350.

Formed in the lower portion of the cabinet 302 are the coin payout port 315 and also the coin receiver 316 for receiving coins paid out from the coin payout port 315. A coin detector 373 made up of a sensor, etc. is disposed inside the coin payout port 315. The coin detector 373 detects the number of coins paid out from the coin payout port 315.

A start lever 317 is attached to a side (a right side as seen in FIG. 10) of the cabinet 302 so as to be pivotable in a predetermined angle range. Such a start lever 317 is annexed with a start switch 357, and when the start lever 317 is pivoted, a switch signal issued from the start switch 357 is outputted to the CPU 350.

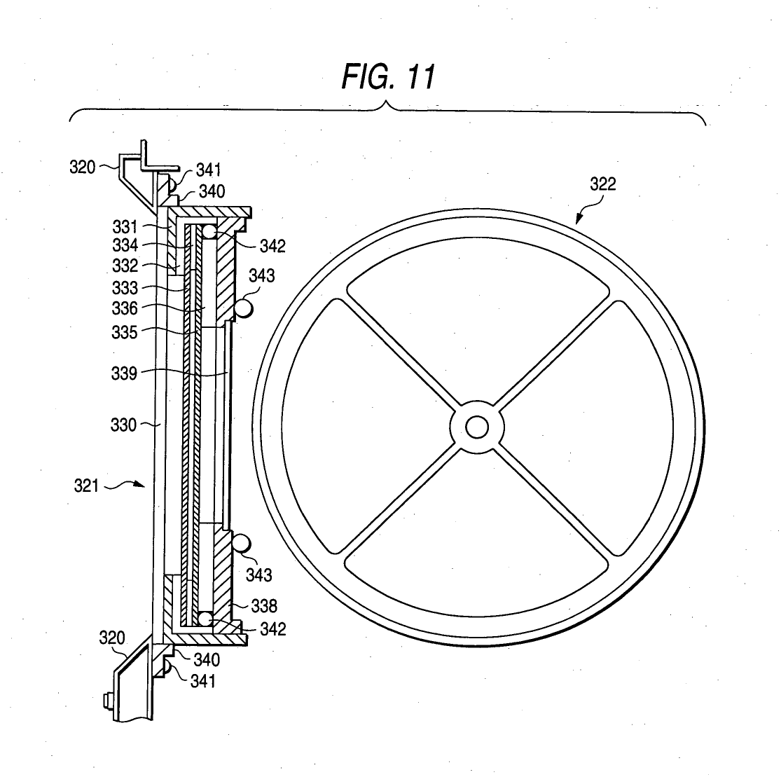

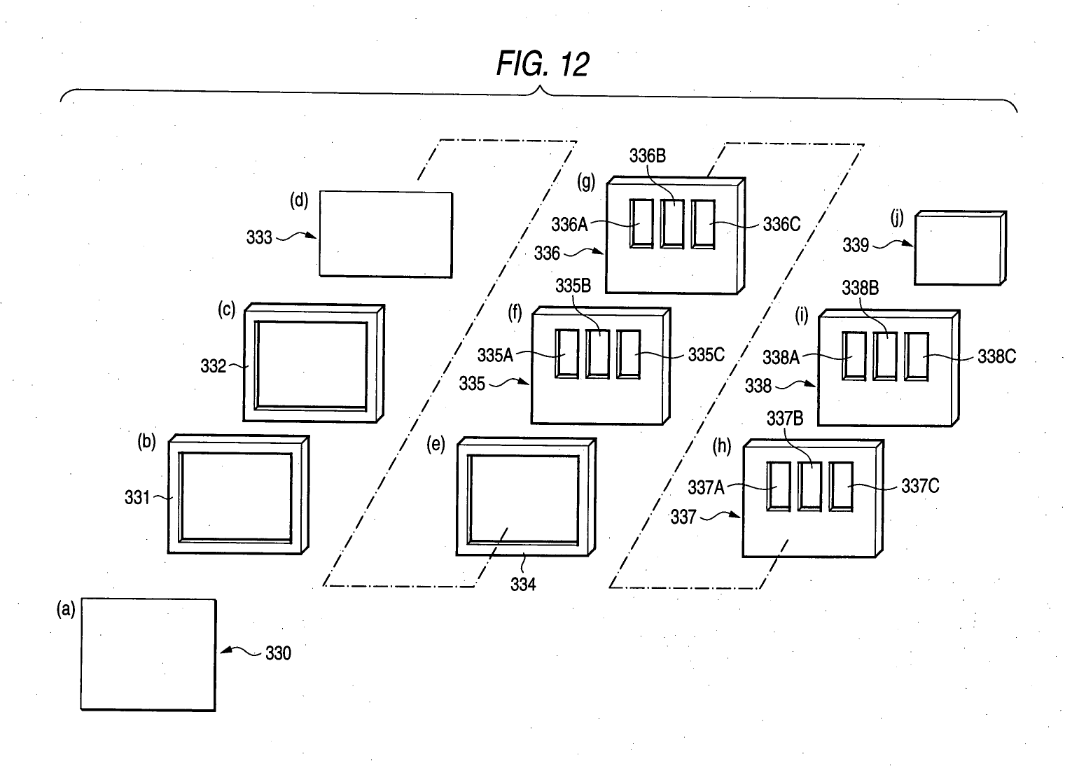

Subsequently, the detailed structure of the lower liquid crystal display 304 and the reel that is disposed on the back side of the lower liquid crystal display 304 so as to be rotatable inside the cabinet 302 will be described according to FIGS. 11 and 12. FIG. 11 is a longitudinal sectional view showing the lower liquid crystal display 304 and the reel 322, and FIG. 12 is a disassembled perspective view of the lower liquid crystal display 304.

In FIGS. 11 and 12, the lower liquid crystal display 304, together with a transparent touch panel 330 (abbreviated hereinafter to “touch panel 330”) disposed on the front side (left side as seen in FIG. 11) thereof, is disposed inwardly of a display window 321 of a machine front panel 320 provided in a front central portion of the cabinet 302 of the slot machine 301. Three reels 322 (FIG. 11 shows only one reel 322) are supported on the back side (right side as seen in FIG. 11) of the lower liquid crystal display 304 so as to be parallel to one another and also rotatable independently one of another.

Now, to describe each reel 322, out of the three reels 322, the reel 322 on the left side as seen from the front of the slot machine 301 is opposite a left display window 323 (see FIG. 10) formed in the lower liquid crystal display 304. The reel 322 on the central side is opposite a central display window 324 (see FIG. 10) similarly formed in the lower liquid crystal display 304. The reel 322 on the right side is opposite a right display window 325 (see FIG. 10) similarly formed in the lower liquid crystal display 304. The configuration of each display window 323, 324, 325 will be described later.

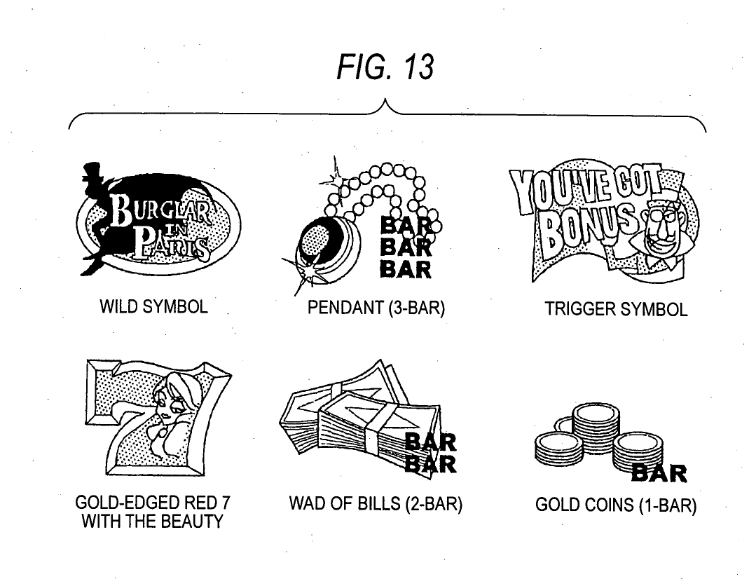

Various kinds (six kinds in FIG. 13) of symbols are formed on the periphery of each reel 322 as shown in FIG. 13. Specifically, as the kinds of symbols formed on the periphery of each reel 322, a WILD symbol, a pendant symbol, a trigger symbol, a RED 7 symbol with the beauty, a wad-of-bill symbol, and a gold coin symbol are used in association with a game content played on the slot machine 301. And, these six kinds of symbols and a blank (a region in which no symbol exists) are combined in a predetermined arrangement manner, thus forming a total of 22 symbol/symbol, symbol/blank, and blank/blank arrangements on the periphery of each reel 322.

Additionally, the slot machine 301 is similar to a conventional slot machine in that various kinds of winning hands are preset based on plurality of arrangements of symbols and that when an arrangement of symbols corresponding to a winning hand stops on a activated pay line L (see FIG. 10), coins are paid out from the coin payout port 315 in response to the winning hand. The description thereof will therefore be omitted herein. The common practice of forming various kinds of symbols on the periphery of each reel 322 is that 11 symbols are pre-printed on an elongated sticker matching the width and perimeter of each reel 322 and that such a sticker is adhered to the periphery of each reel 322. However, it is possible to form symbols by other methods than the aforesaid. These symbols and blank, which correspond to the plural symbols of the first game, are displayed changing as the reels 322 rotate and displayed stopped as the reels 322 stop rotating.

Here, in the embodiment, the activated pay line L refers only to a central line. Such a activated pay line L is displayed on the lower liquid crystal display 304 when a game is played as each reel 322 rotates and stops based on depression of the SPIN button 312, 3-BET button 313, and 5-BET button 314 or on pivotal operation of the start lever 317, i.e., when the first game is played. On the contrary, when the second game is played, the display of the activated pay line L is eliminated from the lower liquid crystal display 304.

The trigger symbol acts as a trigger for obtaining admission to the second game. In the embodiment, one trigger symbol is provided only on the periphery of the right reel 322. The trigger symbol existing on the periphery of the right reel 322 stops on the activated pay line L at the first game, based on which the admission to the second game can be obtained.

That is, the predetermined arrangement for executing the second game is that the trigger symbol stops on the activated pay line L.

Subsequently, the structure of the lower liquid crystal display 304 will be described according to FIGS. 11 and 12. In FIGS. 11 and 12, the lower liquid crystal display 304 includes, having disposed in the order named from the front side of the slot machine 301, a touch panel 330, a reel glass base 331, a metal bezel 332, a liquid crystal panel 333, a liquid crystal holder 334, a diffusion sheet 335, a light guiding plate 336, a white reflector 337, a rear holder 338, and an antistatic sheet 339. Openings 335A, 335B, and 335C are formed in the diffusion sheet 335. Similarly, openings 336A, 336B, 336C, openings 337A, 337B, 337C, and openings 338A, 338B, 338C are formed in the light guiding plate 336, the reflector 337, and the rear holder 338 so as to match the openings 335A to 335C, respectively. The individual openings 335A to 338A, being superimposed one on another so as to match each other, configure the left display window 323 (see FIG. 10). The individual openings 335B to 338B similarly configure the central display window 324 (see FIG. 10), and the individual openings 335C to 338C similarly configure the right display window 325 (see FIG. 10).

Here, the openings 335A to 335C of the diffustion sheet 335 and the openings 336A to 336C of the light guiding plate 336 configure a transparent region for securing the visibility of variable displaying of each reel 322.

To attach the lower liquid crystal display 304 to the display window 321 of the machine front panel 320, as shown in FIG. 11, individual brackets 340 provided protruding in an up and down direction of the reel glass base 331 are screwed by screws 341 to the back of the machine front panel 320.

Cold cathode ray tubes 342 serving as light sources of the liquid crystal panel 333 are disposed as a pair at the respective upper and lower ends of the light guiding plate 336. Cold cathode ray tubes 343 for illuminating the symbols formed on the periphery of each reel 322 are disposed as a pair in respective back side upper and lower portions of each opening 338A to 338C of the rear holder 338.

The liquid crystal panel 333 is a transparent electrical display panel made of ITO, etc. which is disposed at the front of the reels 322 and through which each reel is seen. The back side of the liquid crystal panel 333 in the periphery of its display portion is supported by the liquid crystal holder 334. The light guiding plate 336, being made of a resin panel having optical transparency, is formed with lens cuts for guiding lights emitted from the cold cathode ray tubes 342 positioned on the sides thereof, to the back side of the liquid crystal panel 333. The diffusion sheet 335, being made of a resin sheet having optical transparency, diffuses the lights guided by the light guiding plate 336 and uniformizes the lights irradiating the liquid crystal panel 333. The liquid crystal holder 334 for holding the liquid crystal panel 333, the diffusion sheet 335, and the light guiding plate 336 become unified so that their unified periphery is inserted in the metal bezel 332. Such insertion allows the metal bezel 332 to hold the front side of the liquid crystal panel 333 in the periphery of its display portion.

The liquid crystal holder 334, diffusion sheet 335, and light guiding plate 336 that are unified by fitting in the metal bezel 332 have the unified periphery further inserted in the reel glass base 331 and are thus held on the reel glass base 331 with the display front of the liquid crystal panel 333 being opened. The reel glass base 331 is attached via the screws 341 to the machine front panel 320, whereby the touch panel 330 is pressure bonded to the front of the reel glass base 331 and thus superimposed over the display front of the liquid crystal panel 333.

The rear holder 338 is made of a white resin plate. The metal bezel 332 supported on the reel glass base 331, the liquid crystal holder 334 holding the liquid crystal panel 333, the diffusion sheet 335, and the light guiding plate 336 are held by the rear holder 338 to the reel glass base 331 from behind. The rear holder 338 also functions as a reflecting plate for reflecting the lights emitted from the cold cathode ray tubes 342 to the light guiding plate 336, to the liquid crystal panel 333 side. The antistatic sheet 339, which is transparent, is adhered to the back of the rear holder 338 with double-face tape and covers the backs of the individual openings 338A to 338C formed in the rear holder 338.

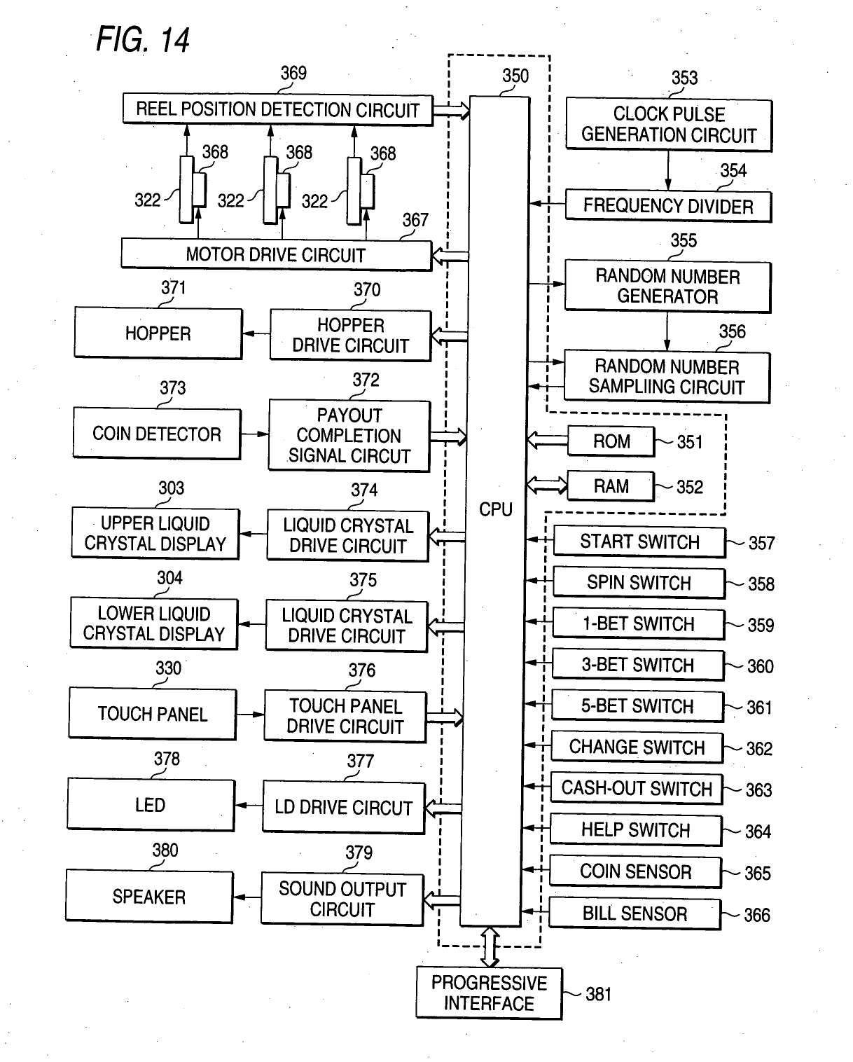

The configuration of the control system of the slot machine 301 will now be described according to FIG. 14. FIG. 14 is a block diagram showing the internal configuration of the slot machine 301.

In FIG. 14, the control system of the slot machine is configured with the CPU 350 as its core, and a ROM 351 and a RAM 352 are connected to the CPU 350. The ROM 351 stores a game control program, various dramatic presentation programs for performing various dramatic presentations on the upper and lower liquid crystal displays 303 and 304 as the game proceeds, other various programs necessary to control the slot machine 301, a data table, and the like. Besides, the RAM 352 is a memory for temporarily storing various data calculated by the CPU 350.

The CPU 350 executes the first game based on the various programs stored in the ROM 351 and executes the second game when the predetermined arrangement is aligned at the first game.

The CPU 350 is connected with a clock pulse generation circuit 353 for generating a reference clock pulse and a frequency divider 354, and also with a random number generator 355 for generating a random number and a random number sampling circuit 356. A random number sampled via the random number sampling circuit 356 is used at various lotteries for drawing symbol per reel 322, a dramatic presentation, and the like. Here, symbols that stops on the activated pay line L is determined as follows. That is, a random number range corresponding to the symbols is set for each reel 322. With reference to a random number value drawn from a predetermined random number range (e.g., a range of “0” to “255”) and to a “probability lottery table (not shown)”, it is determined which symbol random number range the random number value drawn falls in, thereby determining the symbol that stops on the activated pay line L. The CPU 350 is connected with the start switch 357 annexed to the start lever 317, the SPIN switch 358 annexed to the SPIN button 312, the 1-BET switch 359 annexed to the 1-BET button 311, the 3-BET switch 360 annexed to the 3-BET button 313, the 5-BET switch 361 annexed to the 5-BET button 314, the CHANGE switch 362 annexed to the CHANGE button 306, the CASH-OUT switch 363 annexed to the CASH-OUT button 307, and the HELP switch 364 annexed to the HELP button 308. Based on the switch signal outputted from each switch by depression of each button, the CPU 350 performs control to execute various operations corresponding to the individual buttons.

The coin sensor 365 disposed in the coin insertion portion 309 and the bill sensor 366 disposed in the bill insertion portion 310 are connected to the CPU 350. The coin sensor 365 detects coins inserted from the coin insertion portion 309, and the CPU 350 calculates the number of coins inserted, based on the coin detection signal outputted from the coin sensor 365. The bill sensor 366 detects the kind and amount of bills inserted from the bill insertion portion 310, and the CPU 350 calculates the number of coins equivalent to the amount of bills, based on the bill detection signal outputted from the bill sensor 366.

The CPU 350 is connected with three step motors 368 for rotating the respective reels 322 via a motor drive circuit 367 and also with a reel position detection circuit 369. When a motor drive signal is outputted to the motor drive circuit 367 from the CPU 350, each step motor 368 is rotatably driven by the motor drive circuit 367, thereby rotating each reel 322.

On the occasion, after each reel 322 starts rotating, the number of drive pulses supplied to each of the step motors 368 is calculated, and the calculation value is written into a predetermined area of the RAM 352. Besides, a reset pulse is outputted per revolution from each reel 322, and such a reset pulse is inputted to the CPU 350 via the reel position detection circuit 369. When the reset pulse is thus inputted, the calculation value written in the RAM 352 is cleared to “0”. Then, based on a calculation value corresponding to the rotational position of each reel 322 within the range of one revolution and a symbol table in which the rotational position of each reel 322 stored in the ROM 352 is made to correspond to symbols formed on the periphery of each reel 322, the CPU 350 identifies the rotational position of the symbols on each reel 322.

A hopper 371 is connected to the CPU 350 via a hopper drive circuit 370. When a drive signal is outputted from the CPU 350 to the hopper drive circuit 370, the hopper 371 pays out a predetermined number of coins from the coin payout port 315.

The coin detector 373 is connected to the CPU 350 via a payout completion signal circuit 372. The coin detector 373 is disposed inside the coin payout port 315. When it is detected that the predetermined number of coins have been paid out from the coin payout port 315, a coin payout detection signal is outputted from the coin detector 373 to the payout completion signal circuit 372, based on which the payout completion signal circuit 372 outputs a payout completion signal to the CPU 350.

The CPU 350 is connected with the upper liquid crystal display 303 via the payout completion signal circuit 372 and also with the lower liquid crystal display 304 via a liquid crystal drive circuit 375. The touch panel 330 is connected to the CPU 350 via a touch panel drive circuit 376.

An LED 378 is connected to the CPU 350 via an LED drive circuit 377. A large number of LED's 378 are disposed at the front of the slot machine 301 and, upon performance of various dramatic presentations, are controlled as to lighting by the LED drive circuit 377 based on a drive signal from the CPU 350. A sound output circuit 379 and a speaker 380 are connected to the CPU 350, and upon performance of various dramatic presentations, the speaker 380 generates various sound effects based on an output signal from the sound output circuit 379. The CPU 350 is annexed with a progressive interface (I/F) 381.

In the slot machine 301, symbols illustrated on the reels 322 are displayed changing as the reels 322 rotate, and the symbols are displayed stopped as the reels 322 stop rotating, thereby allowing the first game to proceed. The player can visually check the symbols displayed changing or stopped via the lower liquid crystal display 304 that is the so-called transparent liquid crystal display.

And, when, as a result of the first game, the arrangement of plural symbols displayed stopped becomes a predetermined arrangement, or the trigger symbol (see FIG. 14) is included in the plural symbols, then a second game is executed. Since the second game itself is similar to that of the gaming machine 2 and thus has already been described, the description thereof will be omitted here. However, in the slot machine 301, the second game may be executed on the upper liquid crystal display 303 or the lower liquid crystal display 304. Besides, the second game may be executed on each of the upper liquid crystal display 303 and the lower liquid crystal display 304.

Game media (e.g., coins) paid out to the player as a result of the second game may be determined in response to the number of coins bet at the first game and to the number of points won at the second game. Alternatively, as shown below, the configuration may be such for example that common bonuses (so-called progressive bonuses) common to a plurality of the slot machines 301 are pooled and game media corresponding to the common bonuses pooled are paid out from a slot machine 301 that has won a predetermined number of points or more at the second game.

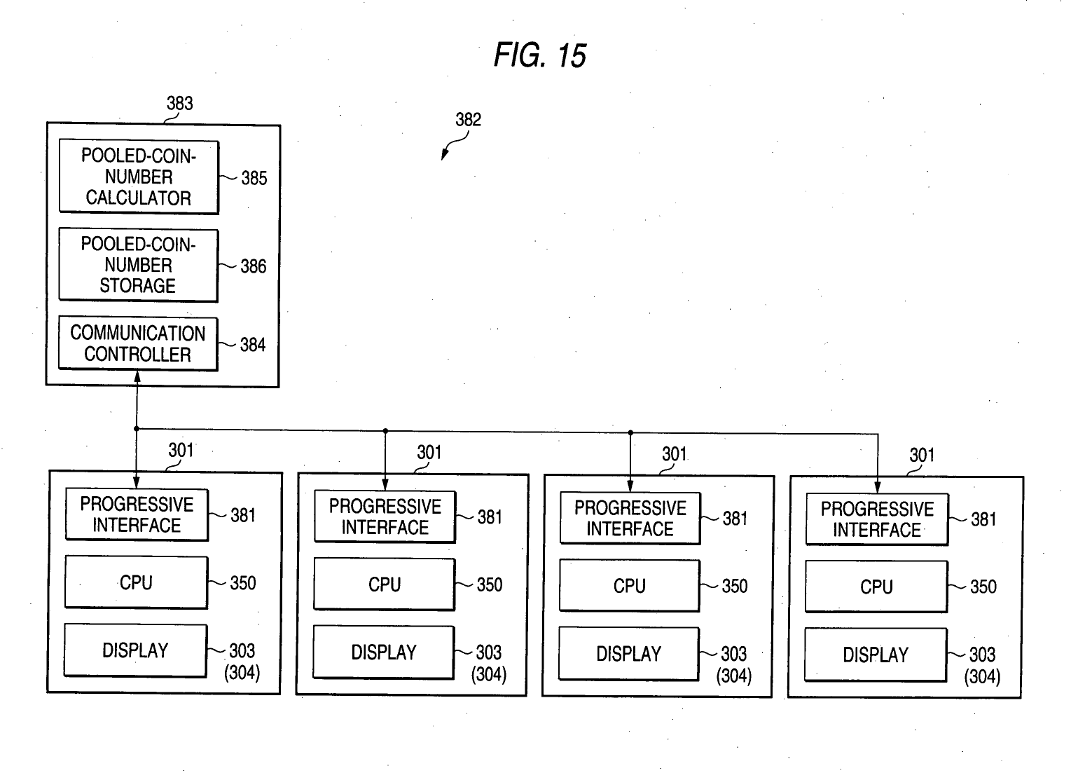

A progressive game system in which the plurality of slot machines 301 are connected together via the progressive I/F 381 annexed to each of them will be described according to FIG. 15. FIG. 15 is an explanatory diagram showing in schematic form the progressive game system 382.

In the progressive game system 382 shown in FIG. 15, the plurality (four in the embodiment) of slot machines 301 are connected to a communication controller 384 of a progressive unit 383 via the progressive I/F 381 annexed to each of them. The progressive unit 383 and each slot machine 301 can be linked together by either wired or wireless connection. This enables two-way communication between the progressive unit 383 and each slot machine 301 via the communication controller 384.

As information transmitted from each slot machine 301 to the progressive unit 383, there are coin insertion information about the number of coins bet at the first game on each slot machine 301, winning information indicating that the first game or the second game is won, score information indicative of points won at a pinball game serving as the second game, and like information. As information transmitted from the progressive unit 383 to each slot machine 301, there are information of the number of pooled coins serving as the common bonuses common to each slot machine 301 and like information.

The symbols of the number of pooled coins serving as the common bonuses is transmitted from the progressive unit 383 via the communication controller 384 to each slot machine 301 and is displayed on the upper liquid crystal display 303 of each slot machine 301. A pooled-coin-number calculator 385 of the progressive unit 383 adds the common bonuses based on the coin insertion information transmitted from each slot machine 301.

Additionally, in each slot machine 301, when a common bonus is won at the first game or the second game, the number of coins corresponding to the common bonus is reset to the initial number of coins. A pooled-coin-number storage 386 stores the number of coins calculated by the pooled-coin-number calculator 385.

The progressive unit 383 configured as aforesaid periodically transmits the pooled-coin-number information stored in the pooled-coin-number storage 386 from the communication controller 384 to each slot machine 301. In each of the slot machine 301, based on the pooled-coin-number information transmitted from the progressive unit 383, the pooled-coin-number information transmitted last time is compared with the pooled-coin-number information transmitted the time. When the current number of pooled coins is smaller than the preceding number of pooled coins, notification is made to the effect that a common bonus has been won on any of the slot machines 301.

In such a case, when the predetermined number of points or more are won at the pinball game serving as the second game, game values (e.g. coins) serving as pooled common bonuses can be obtained from a plurality of the slot machines 301. Therefore, a player's competitive spirit can be aroused to increase interest and concern in the second game. The number of ball images appearing in the pinball game serving as the second game is determined based on symbol or arrangement of the symbols that is displayed stopped at the first game, and the magnitude of the number of ball images determined has influence on the result of the second game. Accordingly, it can therefore increase interest and concern in not only the second game but also the first game itself, which can improve the game's amusing properties.

According to the embodiment, the number of ball images is not always constant, but a number of ball images responsive to the result of the first game are used, which therefore will not tire the player and can improve game's amusing properties. Besides, the player himself/herself can operate the flipper images to play the second game, which therefore makes the player interested in and concerned with the second game itself, so that the player can enjoy the second game.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A gaming machine comprising:
a display device;
a first game controller that performs a first game in which a plurality of symbols are variably displayed and stopped on the display device and a winning combination is determined based on an arrangement of the stopped symbols; and
a second game controller that performs a second game on the display device when a predetermined arrangement is aligned at the first game, the second game of a pinball game in which a flipper image is moved as being operated by a player to flip a ball image moving within a predetermined display region of the display device,
wherein the second game controller determines a number of the ball image to be displayed on the display region in response to the arrangement at the first game.

2. The gaming machine as claimed in claim 1, wherein the second game controller holds lottery when the predetermined arrangement is aligned at the first game and determines the number of the ball image further in response to the result of the lottery.

3. The gaming machine as claimed in claim 1, wherein the second game controller determines the number of the ball image further in response to a total number of bets of game medium made in the first game.

4. A computer-readable program product for causing a computer to execute:
performing a first game in which a plurality of symbols are stopped after being variably displayed on a display device and a winning combination is determined based on an arrangement of the stopped symbols;
determining a number of a ball image to be displayed on a predetermined display region of the display device in response to the arrangement at the first game; and
performing a second game on the display device when the predetermined arrangement is aligned at the first game, the second game of a pinball game in which a flipper image is moved as being operated by a player to flip the ball image moving within the display region.

5. An automatic game performing method executed in a computer comprising the steps of:
performing a first game in which a plurality of symbols are stopped after being variably displayed on a display device and a winning combination is determined based on an arrangement of the stopped symbols;
determining a number of a ball image to be displayed on a predetermined display region of the display device in response to the arrangement the first game; and
performing a second game on the display device when the predetermined arrangement is aligned at the first game, the second game of a pinball game in which a flipper image is moved as being operated by a player to flip the ball image moving within the display region.
